(19) United States
(12) Patent Application Publication
(10) Pub. No.: US 2022/0070392 A1
(43) Pub. Date: Mar. 3, 2022

(54) EVENT SIGNAL DETECTION SENSOR AND CONTROL METHOD

(71) Applicant: SONY SEMICONDUCTOR SOLUTIONS CORPORATION, KANAGAWA (JP)

(72) Inventors: SHINICHIRO IZAWA, KANAGAWA (JP); MOTONARI HONDA, KANAGAWA (JP)

(21) Appl. No.: 17/310,570

(22) PCT Filed: Feb. 7, 2020
(86) PCT No.: PCT/JP2020/004857

§ 371 Date: Aug. 11, 2021

(30) Foreign Application Priority Data
Feb. 21, 2019 (JP) 2019-029414

(51) Int. Cl. H04N 5/351; H04N 5/341

(52) U.S. Cl. CPC H04N 5/351; H04N 5/341

(57) ABSTRACT

The present technology relates to an event signal detection sensor and a control method for shortening latency and reducing overlooking objects. A plurality of pixel circuits detects an event that is a change in an electrical signal of a pixel that generates the electrical signal by performing photoelectric conversion, and outputs event data indicating the occurrence of the event. A detection probability setting unit calculates a detection probability per unit time for detecting the event for each region formed with one or more pixel circuits, in accordance with a result of pattern recognition. The detection probability setting unit controls the pixel circuits in such a manner that event data is output in accordance with the detection probability. The present technology can be applied to an event signal detection sensor that detects an event that is a change in an electrical signal of a pixel.

### TECHNICAL FIELD

The present technology relates to an event signal detection sensor and a control method, and more particularly, to an event signal detection sensor and a control method for shortening latency and reducing overlooking of objects, for example.

### BACKGROUND ART

There is an image sensor that has been developed for outputting event data indicating the occurrence of an event in a case where an event has occurred as an event that is a change in the luminance of a pixel (see Patent Document 1, for example).

Here, an image sensor that performs imaging in synchronization with a vertical synchronization signal, and outputs frame data that is image data of one frame (screen) in the cycle of the vertical synchronization signal can be regarded as a synchronous image sensor. On the other hand, an image sensor that outputs event data can be regarded as an asynchronous (or address-control) image sensor, because such an image sensor outputs event data when an event occurs. An asynchronous image sensor is called a dynamic vision sensor (DVS), for example.

In a DVS, event data is not output unless an event occurs, and event data is output in a case where an event has occurred. Therefore, a DVS has the advantage that the data rate of event data tends to be low, and the latency of event data processing tends to be low.

### CITATION LIST

### Patent Document

Patent Document 1: JP 2017-535999 W

### SUMMARY OF THE INVENTION

### Problems to be Solved by the Invention

Meanwhile, in a case where the background to be captured by the DVS includes trees with luxuriant foliage, for example, the leaves of the trees will sway in the wind, and therefore, the number of pixels in which an event occurs will be large. If there are many pixels in which an event occurs with respect to an object that is not the object of interest to be detected by the DVS, the advantages of DVS such as the low data rate and the low latency will be lost.

Here, an image whose pixel values are gradation signals expressing gradation is used (this image will be hereinafter also referred to as a gradation image), for example, and the region of the object of interest to be detected by the DVS is set as the ROI. Only outputting of event data in the ROI is enabled, and the object of interest (ROI) is tracked. In this manner, the low data rate and the low latency may be maintained.

In this case, however, when a new object of interest appears in an imaging region of the DVS outside the range corresponding to the region set as the ROI, the event data derived from the new object of interest is not output, and the new object of interest cannot be detected and will be overlooked.

The present technology has been made in view of such circumstances, and aims to shorten the latency and reduce overlooking of objects.

### Solutions to Problems

An event signal detection sensor of the present technology is an event signal detection sensor that includes: a plurality of pixel circuits that detect an event that is a change in an electrical signal of a pixel that generates the electrical signal by performing photoelectric conversion, and output event data indicating occurrence of the event; and a detection probability setting unit that calculates, in accordance with a result of pattern recognition, a detection probability per unit time for detecting the event for each region formed with one or more of the pixel circuits, and controls the pixel circuits in so that the event data is output in accordance with the detection probability.

A control method of the present technology is a control method that includes controlling a plurality of pixel circuits of an event signal detection sensor that includes: the pixel circuits that detect an event that is a change in an electrical signal of a pixel that generates the electrical signal by performing photoelectric conversion, and output event data indicating occurrence of the event. In the control method, the pixel circuits are controlled in accordance with a result of pattern recognition, so that a detection probability per unit time for detecting the event is calculated for each region formed with one or more of the pixel circuits, and the event data is output in accordance with the detection probability.

According to the present technology, a plurality of pixel circuits is controlled in an event signal detection sensor including the pixel circuits that detect an event that is a change in an electrical signal of a pixel that generates the electrical signal by performing photoelectric conversion, and output event data indicating the occurrence of the event. That is, in accordance with a result of pattern recognition, a detection probability per unit time for detecting the event is calculated for each region formed with one or more of the pixel circuits, and the pixel circuits are controlled so that the event data is output in accordance with the detection probability.

Note that the sensor may be an independent device, or may be internal blocks constituting a single device. Alternatively, the sensor can be formed as a module or a semiconductor chip.

### BRIEF DESCRIPTION OF DRAWINGS

FIG. 1 is a block diagram showing an example configuration of an embodiment of a DVS to which the present technology is applied.

FIG. 2 is a block diagram showing a first example configuration of a pixel circuit 21.

FIG. 3 is a diagram for explaining a process in a normal mode in a DVS.

FIG. 4 is a flowchart for explaining a process in a detection probability mode in the DVS.

FIG. 5 is a diagram for explaining a process in the detection probability mode in the DVS.

FIG. 6 is a block diagram showing a second example configuration of a pixel circuit 21.

FIG. 7 is a diagram showing an example of detection probability setting.

FIG. 8 is a diagram for explaining an example of reset control that depends on detection probabilities and is performed in the second example configuration of a pixel circuit 21.

FIG. 9 is a block diagram showing a third example configuration of a pixel circuit 21.

FIG. 10 is a diagram for explaining an example of threshold control that depends on detection probabilities and is performed in the third example configuration of a pixel circuit 21.

FIG. 11 is a block diagram showing a fourth example configuration of a pixel circuit 21.

FIG. 12 is a diagram for explaining an example of current control that depends on detection probabilities and is performed in the fourth example configuration of a pixel circuit 21.

FIG. 13 is a diagram showing an example of spatial decimation of event data outputs.

FIG. 14 is a diagram showing another example of spatial decimation of event data outputs.

FIG. 15 is a diagram showing an example of temporal decimation of event data outputs.

FIG. 16 is a block diagram schematically showing an example configuration of a vehicle control system.

FIG. 17 is an explanatory diagram showing an example of installation positions of external information detectors and imaging units.

### MODE FOR CARRYING OUT THE INVENTION

<Embodiment of a DVS to Which the Present Technology Is Applied>

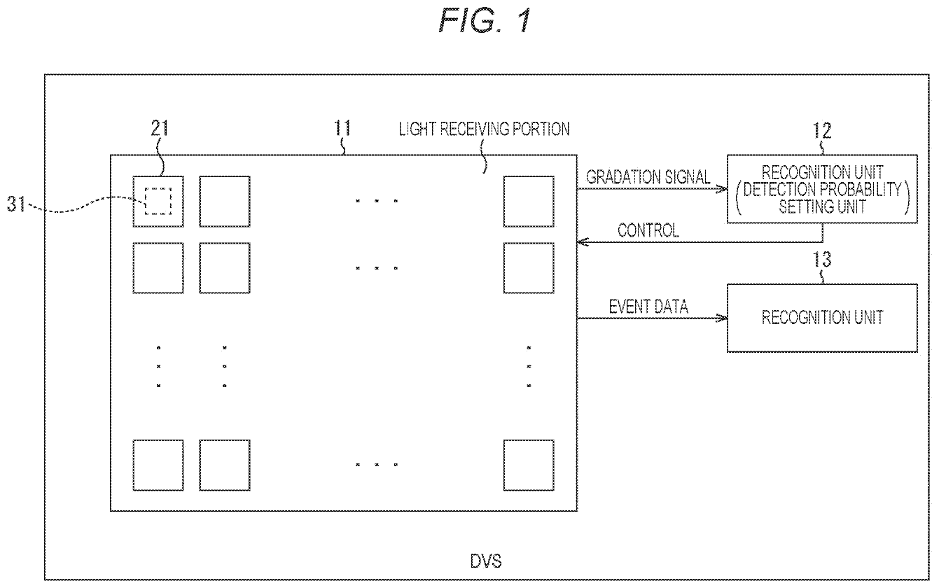

FIG. 1 is a block diagram showing an example configuration of an embodiment of a DVS as a sensor (an event signal detection sensor) to which the present technology is applied.

In FIG. 1, the DVS includes a pixel array unit 11, and recognition units 12 and 13.

The pixel array unit 11 is formed with a plurality of pixel circuits 21 arranged in a grid-like pattern in a two-dimensional plane, the pixel circuits 21 including pixels 31 that perform photoelectric conversion on incident light to generate electrical signals. The pixel array unit 11 performs imaging to generate electrical signals by performing photoelectric conversion on incident light at the pixels 31. The pixel array unit 11 further generates event data representing the occurrence of an event that is a change in the electrical signal of the pixel 31 in a pixel circuit 21, and outputs the event data to the recognition unit 13 under the control of the recognition unit 12. The pixel array unit 11 also generates gradation signals expressing the gradation of an image, from the electrical signals of the pixels 31, and supplies the gradation signals to the recognition unit 12.

As described above, the pixel array unit 11 outputs the gradation signals in addition to the event data. Accordingly, the pixel array unit 11 can function as a synchronous image sensor that performs imaging in synchronization with a vertical synchronization signal, and outputs the gradation signals of the image of one frame (screen) in the cycle of the vertical synchronization signal.

Here, in the pixel array unit 11, the portion in which the plurality of pixel circuits 21 is disposed is also referred to as the light receiving portion, because it is a portion that receives incident light and performs photoelectric conversion in the entire configuration.

The recognition unit 12 functions as a detection probability setting unit that performs pattern recognition on a gradation image whose pixel values are the gradation signals output by the pixel array unit 11, and calculates (sets) a detection probability per event-detecting time for each region formed with one or more pixel circuits 21 of the pixel array unit 11.

The recognition unit 12 further controls the pixel circuits 21 in accordance with the detection probability so that event data is output depending on the detection probability. Note that, in a case where the DVS has an arbiter (not shown) that mediates an output of event data, the pixel circuits 21 can be controlled from the recognition unit 12 via the arbiter in accordance with the detection probability.

The recognition unit 13 performs pattern recognition on an event image whose pixel values are the values corresponding to the event data output by the pixel array unit 11, detects the object of interest to be detected by the DVS, and tracks the object of interest (follows the object of interest).

Note that the DVS can be formed with a plurality of dies that are stacked. In a case where the DVS is formed with two stacked dies, for example, the pixel array unit 11 can be formed in one of the two dies, and the recognition units 12 and 13 can be formed in the other one of the dies. Alternatively, one of the dies can form part of the pixel array unit 11, and the other one of the dies can form the remaining part of the pixel array unit 11 and the recognition units 12 and 13.

[First Example Configuration of a Pixel Circuit 21]

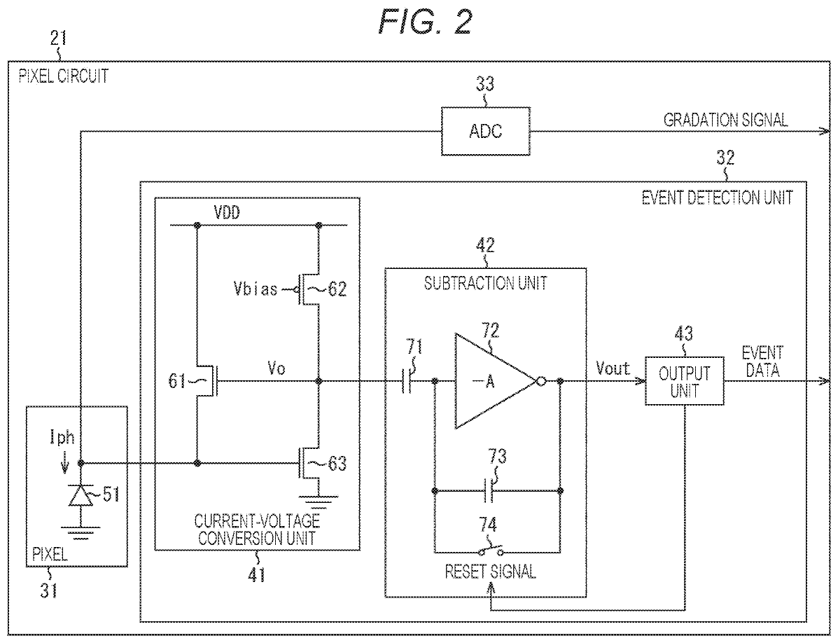

FIG. 2 is a block diagram showing a first example configuration of a pixel circuit 21 shown in FIG. 1.

The pixel circuit 21 includes a pixel 31, an event detection unit 32, and an analog-to-digital converter (ADC) 33.

The pixel 31 includes a photodiode (PD) 51 as a photoelectric conversion element. The pixel 31 receives light incident on the PD 51, performs photoelectric conversion, and generates and applies a photocurrent (Iph) as an electrical signal, at the PD 51.

In a case where a change exceeding a predetermined threshold is caused in the photocurrent generated by the photoelectric conversion in the pixel 31, the event detection unit 32 detects the change in the photocurrent as an event. The event detection unit 32 outputs event data as a result of (the detection of) the event.

Here, the change in the photocurrent generated in the pixel 31 can be regarded as a change in the amount of light entering the pixel 31, and accordingly, the event can also be regarded as a change in the amount of light in the pixel 31 (a light amount change exceeding the threshold).

As for the event data, at least the location information (such as the coordinates) indicating the location of the pixel (the pixel circuit 21) in which the light amount change as an event has occurred can be identified. Further, as for the event data, the polarity (positive or negative) of the light intensity change can be identified.

As for the series of event data output by the event detection unit 32 at the timing when the event occurred, the time information indicating the (relative) time at which the event occurred can be identified, as long as the intervals between the pieces of event data are maintained as they were at the time of the event occurrence. However, when the intervals between the pieces of event data are no longer maintained as they were at the time of the event occurrence due to the storage of the event data in a memory or the like, the time information will be lost. Therefore, as for the event data, the time information indicating the (relative) time at which the event occurred, such as a time stamp, is added to the event data, before the intervals between the pieces of event data are no longer maintained as they were at the time of the event occurrence. The process of adding the time information to the event data may be performed in the event detection unit 32 or outside the event detection unit 32, before the intervals between the pieces of event data are no longer maintained as they were at the time of the event occurrence.

The event detection unit 32 includes a current-voltage conversion unit 41, a subtraction unit 42, and an output unit 43.

The current-voltage conversion unit 41 converts the photocurrent from the pixel 31 into a voltage (hereinafter, also referred to as the optical voltage) Vo corresponding to the logarithm of the photocurrent, and outputs the voltage Vo to the subtraction unit 42.

The current-voltage conversion unit 41 is formed with FETs 61 to 63. For example, N-type MOSFETs can be adopted as the FETs 61 and 63, and a P-type MOS (PMOS) FET can be adopted as the FET 62.

The source of the FET 61 is connected to the gate of the FET 63, and the photocurrent from the pixel 31 flows at the connecting point between the source of the FET 61 and the gate of the FET 63. The drain of the FET 61 is connected to a power supply VDD, and the gate is connected to the drain of the FET 63.

The source of the FET 62 is connected to the power supply VDD, and the drain is connected to the connecting point between the gate of the FET 61 and the drain of the FET 63. A predetermined bias voltage Vbias is applied to the gate of the FET 62.

The source of the FET 63 is grounded.

In the current-voltage conversion unit 41, the FET 61 has its drain connected to the side of the power supply VDD, and serves as a source follower. The PD 51 of the pixel 31 is connected to the source of the FET 61, which is the source follower. With this arrangement, the photocurrent formed with the electric charge generated by the photoelectric conversion at the PD 51 of the pixel 31 flows in the FET 61 (from the drain to the source). The FET 61 operates in a subthreshold region, and the optical voltage Vo corresponding to the logarithm of the photocurrent flowing in the FET 61 appears at the gate of the FET 61. As described above, in the current-voltage conversion unit 41, the FET 61 converts the photocurrent from the pixel 31 into the optical voltage Vo corresponding to the logarithm of the photocurrent.

The optical voltage Vo is output from the connecting point between the gate of the FET 61 and the drain of the FET 63, to the subtraction unit 42.

With respect to the optical voltage Vo from the current-voltage conversion unit 41, the subtraction unit 42 calculates the difference between the current optical voltage and the optical voltage at a timing different from the present time by a small amount of time, and outputs a difference signal Vout corresponding to the difference to the output unit 43.

The subtraction unit 42 includes a capacitor 71, an operational amplifier 72, a capacitor 73, and a switch 74.

One end of the capacitor 71 (a first capacitance) is connected to (the connecting point between the FETs 62 and 63 of) the current-voltage conversion unit 41, and the other end is connected to the input terminal of the operational amplifier 72. Accordingly, the optical voltage Vo is input to the (inverting) input terminal of the operational amplifier 72 via the capacitor 71.

The output terminal of the operational amplifier 72 is connected to the output unit 43.

One end of the capacitor 73 (a second capacitance) is connected to the input terminal of the operational amplifier 72, and the other end is connected to the output terminal of the operational amplifier 72.

The switch 74 is connected to the capacitor 73, so as to turn on and off the connections at both ends of the capacitor 73. The switch 74 turns on or off the connections at both ends of the capacitor 73 in accordance with a reset signal from the output unit 43.

The capacitor 73 and the switch 74 constitute a switched capacitor. When the switch 74 that has been turned off is temporarily turned on and is then turned off again, the capacitor 73 is reset to a state in which the electric charge is released and new electric charge can be accumulated.

The optical voltage Vo of the capacitor 71 on the side of the current-voltage conversion unit 41 when the switch 74 is on is represented by Vinit, and the capacitance (electrostatic capacitance) of the capacitor 71 is represented by C1. The input terminal of the operational amplifier 72 is virtually grounded, and the electric charge Qinit accumulated in the capacitor 71 in a case where the switch 74 is on is expressed by Equation (1).

Qinit=C1×Vinit (1)

Further, in a case where the switch 74 is on, both ends of the capacitor 73 are short-circuited, and accordingly, the electric charge accumulated in the capacitor 73 is zero.

After that, if the optical voltage Vo of the capacitor 71 on the side of the current-voltage conversion unit 41 in a case where the switch 74 is off is represented by Vafter, the electric charge Qafter accumulated in the capacitor 71 in a case where the switch 74 is expressed by Equation (2).

Qafter=C1×Vafter (2)

Where the capacitance of the capacitor 73 is represented by C2, the electric charge Q2 accumulated in the capacitor 73 is expressed by Equation (3) using the difference signal Vout, which is the output voltage of the operational amplifier 72.

Q2=−C2×Vout (3)

Before and after the switch 74 is turned off, the total amount of electric charge, which is the sum of the electric charge in the capacitor 71 and the electric charge in the capacitor 73, does not change, and accordingly, Equation (4) holds.

Qinit=Qafter+Q2 (4)

Where Equations (1) to (3) are substituted into Equation (4), Equation (5) is obtained.

Vout=−(C1/C2)×(Vafter−Vinit) (5)

According to Equation (5), the subtraction unit 42 subtracts the optical voltage Vinit from the optical voltage Vafter, or calculates the difference signal Vout corresponding to the difference between the optical voltages Vafter and Vinit: Vafter−Vinit. According to Equation (5), the subtraction gain of the subtraction unit 42 is C1/C2. Accordingly, the subtraction unit 42 outputs the voltage obtained by multiplying the change in the optical voltage Vo after resetting of the capacitor 73 by C1/C2, as the difference signal Vout.

The output unit 43 compares the difference signal Vout output by the subtraction unit 42 with predetermined thresholds (voltages) +Vth and −Vth to be used for detecting events. In a case where the difference signal Vout is equal to or greater than the threshold +Vth, or is equal to or smaller than the threshold −Vth, the output unit 43 outputs event data, determining that a change in the amount of light as an event has been detected (or has occurred).

For example, in a case where the difference signal Vout is equal to or greater than the threshold +Vth, the output unit 43 outputs event data of +1, determining that a positive event has been detected. In a case where the difference signal Vout is equal to or smaller than the threshold −Vth, the output unit 43 outputs event data of −1, determining that a negative event has been detected.

When an event is detected, the output unit 43 resets the capacitor 73 by outputting a reset signal for temporarily turning the switch 74 on and then turning it off.

Note that, if the switch 74 is left on, the difference signal Vout is fixed at a predetermined reset level, and the event detection unit 32 cannot detect any change in the amount of light as an event. Likewise, in a case where the switch 74 is left off, the event detection unit 32 cannot detect any change in the amount of light as an event.

Here, an optical filter such as a color filter that transmits predetermined light is provided in the pixel 31, so that the pixel 31 can receive desired light as incident light. For example, in a case where the pixel 31 receives visible light as incident light, the event data indicates the occurrence of a change in a pixel value in an image showing a visible object. Also, in a case where the pixel 31 is to receive infrared rays, millimeter waves, or the like for distance measurement as incident light, for example, the event data indicates the occurrence of a change in the distance to the object. Further, in a case where the pixel 31 is to receive infrared rays for measuring temperature as incident light, for example, the event data indicates the occurrence of a change in the temperature of the object. In this embodiment, the pixel 31 is to receive visible light as incident light.

Further, in a case where the DVS is formed with two stacked dies, for example, the entire pixel circuits 21 can be formed in one die, or the pixels 31 and the current-voltage conversion units 41 can be formed in one die while the other components are formed in the other die.

The ADC 33 performs AD conversion on the photocurrent flowing from the pixel 31, and outputs the digital value obtained by the AD conversion as a gradation signal.

The pixel circuit 21 designed as above can output event data and a gradation signal at the same time.

Here, in the DVS (FIG. 1), the recognition unit 13 generates an event image having a value corresponding to the event data output by the pixel circuit 21 (the output unit 43) as a pixel value, and performs pattern recognition on the event image.

The event image is generated in each predetermined frame interval, in accordance with the event data within a predetermined frame width from the beginning of the predetermined frame interval.

Here, the frame interval means the interval between adjacent frames of the event image. The frame width means the time width of the event data that is used for generating an event image of one frame.

Here, the time information indicating the time at which the event has occurred (hereinafter, also referred to as the event time) is represented by t, and the coordinates as the location information (hereinafter, also referred to as the event location) of (the pixel circuit 21 including) the pixel 31 in which the event has occurred are represented by (x, y).

In a three-dimensional (time) space formed with the x-axis, the y-axis, and the time axis t, a rectangular parallelepiped having a predetermined frame width (time) in the direction of the time axis t in each predetermined frame interval will be hereinafter referred to as a frame volume. The sizes of the frame volume in the x-axis direction and the y-axis direction are equal to the number of the pixel circuits 21 or the pixels 31 in the x-axis direction and the y-axis direction, respectively, for example.

In each predetermined frame interval, the recognition unit 12 generates an event image of one frame, in accordance with the event data (or using the event data) in the frame volume having a predetermined frame width from the start of the frame interval.

It is possible to generate the event image by setting (the pixel value of) the pixel in the frame at the event location (x, y) to white, and the pixels at the other positions in the frame to a predetermined color such as gray, for example.

Further, in a case where the polarity of a change in the amount of light as an event can be identified with respect to event data, frame data can be generated, with the polarity being taken into consideration. For example, in a case where the polarity is positive, the pixel can be set to white, and, in a case where the polarity is negative, the pixel can be set to black.

Operation modes for the DVS designed as above includes include a normal mode and a detection probability mode, for example.

In the normal mode, all of the pixel circuits 21 constituting the pixel array unit 11 operate in similar manners (uniformly) according to predetermined specifications. Therefore, in the normal mode, in a case where incident light having a light amount change from which an event is to be detected in one pixel circuit 31 enters another pixel circuit 31, the event is also detected in the other pixel circuit 31, and event data is also output from the other pixel circuit 31.

In the detection probability mode, on the other hand, the recognition unit 12 sets (calculates) a detection probability in each region in one or more pixel circuits 21, and controls the pixel circuits 21 so as to output event data in accordance with the detection probability. Therefore, in the detection probability mode, in a case where incident light having light amount change from which an event is to be detected in one pixel circuit 31 enters another pixel circuit 31, event data is not necessarily output from the other pixel circuit 31. Further, in a case where incident light having a light amount change with which event data is not to be output from one pixel circuit 31 enters another pixel circuit 31, an event can be detected in the other pixel circuit 31, and event data can be output from the other pixel circuit 31.

<Normal Mode>

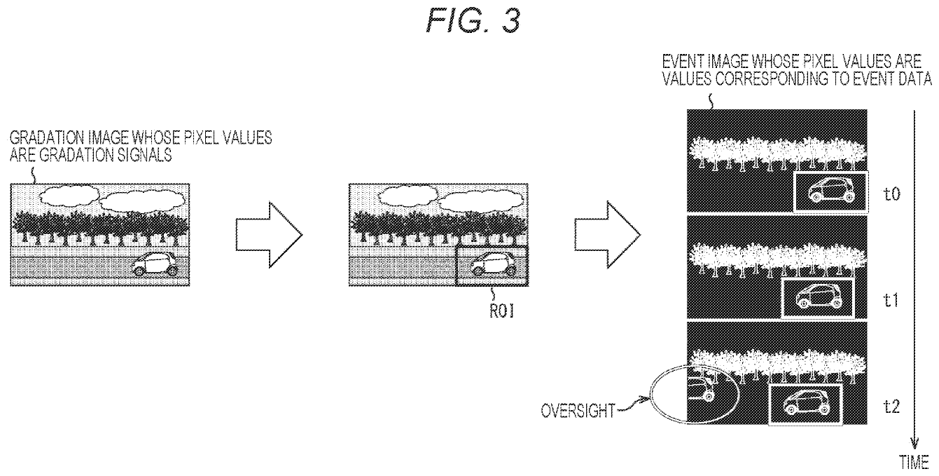

FIG. 3 is a diagram for explaining a process in the normal mode in the DVS.

In the normal mode, all of the pixel circuits 21 constituting the pixel array unit 11 detect a light amount change exceeding a certain threshold as an event, and output event data.

Therefore, in a case where the background to be captured by the DVS includes trees with luxuriant foliage, for example, the leaves of the trees will sway in the wind, and therefore, the number of pixels 31 in which an event occurs, or the amount of event data, will be very large. Where the amount of event data is very large, the latency of the processing of such a large amount of event data is long.

Therefore, in the normal mode, the recognition unit 12 can perform pattern recognition on a gradation image whose pixel values are the gradation signals output by the respective pixel circuits 21 of the pixel array unit 11. Further, as shown in FIG. 3, the recognition unit 12 can set an ROI that is the region of the object of interest to be detected by the DVS, in accordance with the result of the pattern recognition. The recognition unit 12 then causes the pixel circuits 21 in the ROI to output event data. In turn, the recognition unit 13 performs pattern recognition on the event image whose pixel value is the value corresponding to the event data, and tracks the object of interest (ROI). Thus, it is possible to prevent the latency of the event data processing from becoming longer due to an increase in the amount of event data.

However, in a case where only the pixel circuits 21 in the ROI are made to output event data, when a new object of interest appears in a region outside the ROI, the event data derived from the new object of interest is not output, and the new object of interest cannot be detected and will be overlooked.

In FIG. 3, at times t0, t1, and t2, the ROI including the automobile as the object of interest is tracked (detection of the object of interest) through pattern recognition for the event image.

Also, in FIG. 3, at time t2, another automobile as a new object of interest appears in the lower left, but the other automobile appears in a region outside the ROI. Therefore, the other automobile is not detected and is overlooked. Note that, in a case where only the pixel circuits 21 in the ROI are made to output event data, the event image does not actually show the another automobile in the lower left. However, the other automobile in the lower left is shown in this drawing, for ease of explanation.

<Detection Probability Mode>

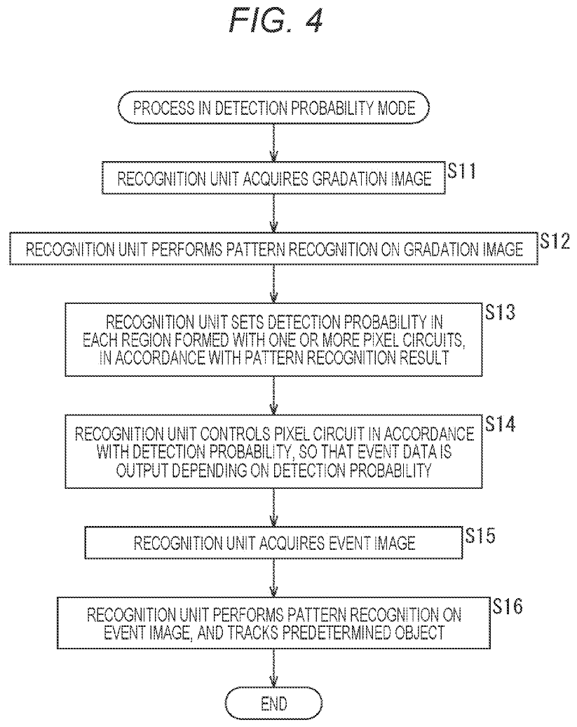

FIG. 4 is a flowchart for explaining a process in the detection probability mode in the DVS.

In step S11, the recognition unit 12 acquires (generates) a gradation image whose pixel values are the gradation signals output by the respective pixel circuits 21 of the pixel array unit 11, and the process moves on to step S12.

In step S12, the recognition unit 12 performs pattern recognition on the gradation image, and the process moves on to step S13.

In step S13, in accordance with the result of the pattern recognition performed on the gradation image, the recognition unit 12 sets a detection probability in each unit region formed with one or more pixel circuits of the pixel array unit 11, and the process moves on to step S14.

In step S14, in accordance with the detection probability, the recognition unit 12 controls the pixel circuits 21 so that event data is output from the pixel circuits 21 in accordance with the detection probability set in the region formed with the pixel circuits 21. The process then moves on to step S15.

In step S15, the recognition unit 13 acquires (generates) an event image whose pixel value is the value corresponding to the event data output by the pixel circuits 21 under the control of the recognition unit 12, and the process moves on to step S16.

In step S16, the recognition unit 13 performs pattern recognition on the event image, and detects and tracks the object of interest, in accordance with the result of the pattern recognition.

Here, in a case where the detection probability is 0.5 in controlling the pixel circuits 21 in accordance with the detection probability set by the recognition unit 12, for example, the pixel circuits 21 are controlled so as to output event data only in response to (detection of) one event out of two events. Alternatively, the outputs of event data are decimated by half.

Further, in a case where the detection probability is 0.1, for example, the pixel circuits 21 are controlled so as to output event data only in response to one event out of ten events. Alternatively, the outputs of event data are decimated to 1/10.

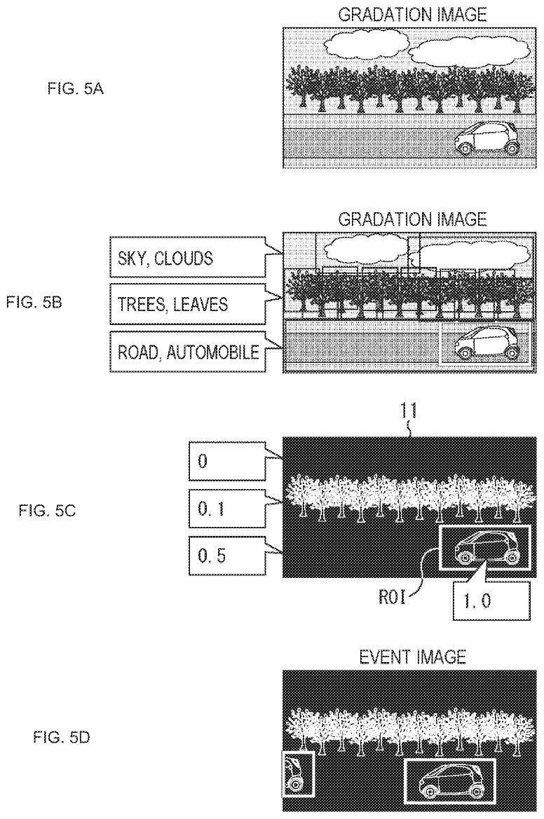

FIG. 5 is a diagram for explaining a process in the detection probability mode in the DVS.

A of FIG. 5 shows an example of a gradation image. The gradation image in A of FIG. 5 shows the sky and clouds in the upper portion, and trees with luxuriant foliage in the middle portion. Further, a road and an automobile traveling on the road from right to left are shown in the lower portion.

B of FIG. 5 shows an example of the result of pattern recognition performed on the gradation image in A of FIG. 5 by the recognition unit 12.

In B of FIG. 5, the sky and the clouds shown in the upper portion of the gradation image, the leaves and the trees shown in the middle portion, and the road and the automobile shown in the lower portion are recognized through the pattern recognition.

C of FIG. 5 shows an example of setting of the detection probability corresponding to the result of the pattern recognition shown in B of FIG. 5.

The recognition unit 12 sets a probability of event detection in each unit region formed with one or more pixel circuits 21, in accordance with the result of the pattern recognition performed on the gradation image.

For example, the automobile is currently set the object of interest. In a case where the recognition unit 12 recognizes the automobile as the object of interest through pattern recognition, (the light receiving portion of) the pixel array unit 11 can set the ROI, which is the region of (the rectangle including) the pixel circuits 21 at which light from the automobile as the object of interest has been received, and set the detection probability in the ROI to 1. The recognition unit 12 can then set the detection probability in the region of the pixel circuits 21 at which light from the objects other than the object of interest has been received (the region other than the ROI), to a smaller value than 1 (but not smaller than 0).

Further, a priority level indicating the degree at which detection of the object is prioritized can be assigned to each object. In this case, the recognition unit 12 can set the detection probability corresponding to the priority level assigned to the object in the region of the pixel circuits 21 at which light from the object recognized through pattern recognition has been received. For example, the higher the priority level is, the higher a detection probability can be set.

In C of FIG. 5, the detection probability in the region of the pixel circuits 21 at which light from the sky and the clouds has been received is set to 0, and the detection probability in the region of the pixel circuits 21 at which light from the leaves and the trees has been received is set to 0.1. Further, the detection probability in the region of the pixel circuits 21 at which light from the road has been received is set to 0.5, and the detection probability in the region of the ROI, which is the region of the pixel circuits 21 at which light from the automobile has been received, is set to 1.

D of FIG. 5 shows an example of the event image to be obtained in a case where the detection probabilities shown in C of FIG. 5 are set.

In the detection probability mode, after detection probabilities are set, the pixel circuits 21 are controlled in accordance with the detection probabilities so that event data will be output in accordance with the detection probabilities. Therefore, outputs of event data from the pixel circuits 21 in the regions in which low detection probabilities are set are reduced. Accordingly, the latency of the event data processing can be prevented from becoming longer due to an increase in the amount of event data. That is, the latency can be shortened.

Further, in the region of each object recognized through pattern recognition, the possibility that an object of interest will appear in that region is set as the priority level, for example, and a detection probability is set in accordance with the priority level. Thus, in the pattern recognition to be performed on an event image, it is possible to prevent a new object of interest from being undetected (unrecognized) and overlooked.

[Second Example Configuration of a Pixel Circuit 21]

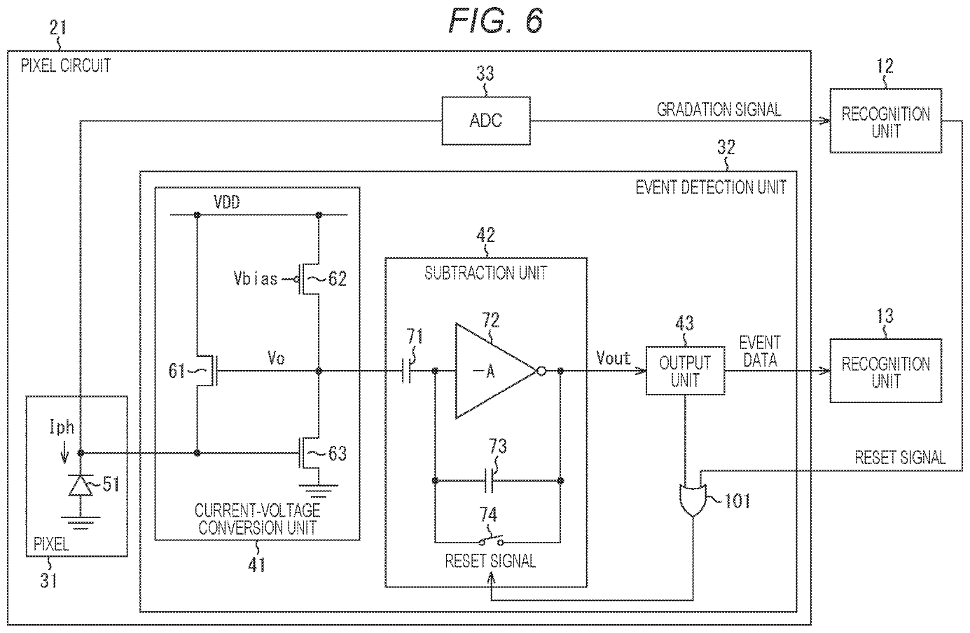

FIG. 6 is a block diagram showing a second example configuration of a pixel circuit 21 shown in FIG. 1.

Note that, in the drawing, the components equivalent to those in the case of FIG. 2 are denoted by the same reference numerals as those used in FIG. 2, and explanation of them will not be repeated in the description below.

In FIG. 6, the pixel circuit 21 includes components from pixels 31 to an ADC 33, and an event detection unit 32 includes components from a current-voltage conversion unit 41 to an output unit 43, and an OR gate 101.

Accordingly, the pixel circuit 21 in FIG. 6 is the same as that in the case illustrated in FIG. 2, in that the pixel circuit 21 includes the components from the pixels 31 to the ADC 33, and the event detection unit 32 includes the components from the current-voltage conversion unit 41 to the output unit 43.

However, the pixel circuit 21 in FIG. 6 differs from that in the case illustrated in FIG. 2, in that the event detection unit 32 further includes the OR gate 101.

In FIG. 6, the recognition unit 12 performs reset control by outputting a reset signal to the pixel circuit 21 as control on the pixel circuit 21 in accordance with a detection probability.

A reset signal output by the output unit 43 and the reset signal output by the recognition unit 12 are supplied to the input terminal of the OR gate 101.

The OR gate 101 calculates the logical sum of the reset signal from the output unit 43 and the reset signal from the recognition unit 12, and supplies the calculation result as a reset signal to the switch 74.

Accordingly, in FIG. 6, the switch 74 is turned on or off in accordance with the reset signal output by the recognition unit 12, as well as the reset signal output by the output unit 43. Thus, the capacitor 73 can be reset not only from the output unit 43 but also from the recognition unit 12. As described above with reference to FIG. 2, resetting the capacitor 73 means turning off the switch 74 after temporarily turning on the switch 74 so that the electric charge of the capacitor 73 is released to allow accumulation of new electric charge.

The recognition unit 12 performs reset control to control resetting of the capacitor 73 by turning on and off the output of the reset signal for keeping the switch 74 on or off in accordance with the detection probability. Thus, event data is output in accordance with the detection probability.

That is, as described above with reference to FIG. 2, if the switch 74 is left on or off, the capacitor 73 is not reset, and the event detection unit 32 becomes unable to detect a light amount change as an event. Therefore, in a case where an event is detected (in a case where the difference signal Vout is equal to or greater than the threshold +Vth, and the difference signal Vout is equal to or smaller than the threshold −Vth), the capacitor 73 is not always reset, but reset control is performed to reduce the frequency of resetting, in accordance with the detection probability. In this manner, event data can be output in accordance with the detection probability.

Since the capacitor 73 is reset by turning off the switch 74 after temporarily turning on the switch 74, turning off the switch 74 after temporarily turning on the switch 74 is also called resetting of the switch 74. The reset control is the control on resetting of the capacitor 73 and the control of resetting of the switch 74 at the same time.

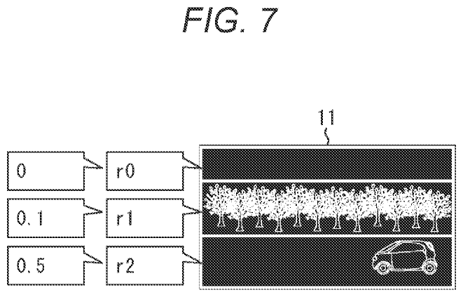

FIG. 7 is a diagram showing an example of detection probability setting.

The recognition unit 12 performs pattern recognition on a gradation image whose pixel values are gradation signals, and, in accordance with the result of the pattern recognition, sets a detection probability in each unit region formed with one or more pixel circuits 21 of the pixel array unit 11. For example, the recognition unit 12 can set a detection probability of a relatively great value between 0 and 1 in the region of the pixel circuits 21 at which light from the object of interest has been received, and in the region of the pixel circuits 21 at which light from the object of interest is likely to be easily received. The recognition unit 12 can set a detection probability of the value of 0 or a value close to 0 in a region at which light from the object of interest is not to be received.

In FIG. 7, in accordance with a result of pattern recognition, the light receiving portion of the pixel array unit 11 is divided into the three regions of an upper region r0, a middle region r1, and a lower region r2. A detection probability of 0 is set in the region r0, a detection probability of 0.1 is set in the region r1, and a detection probability of 0.5 is set in the region r2.

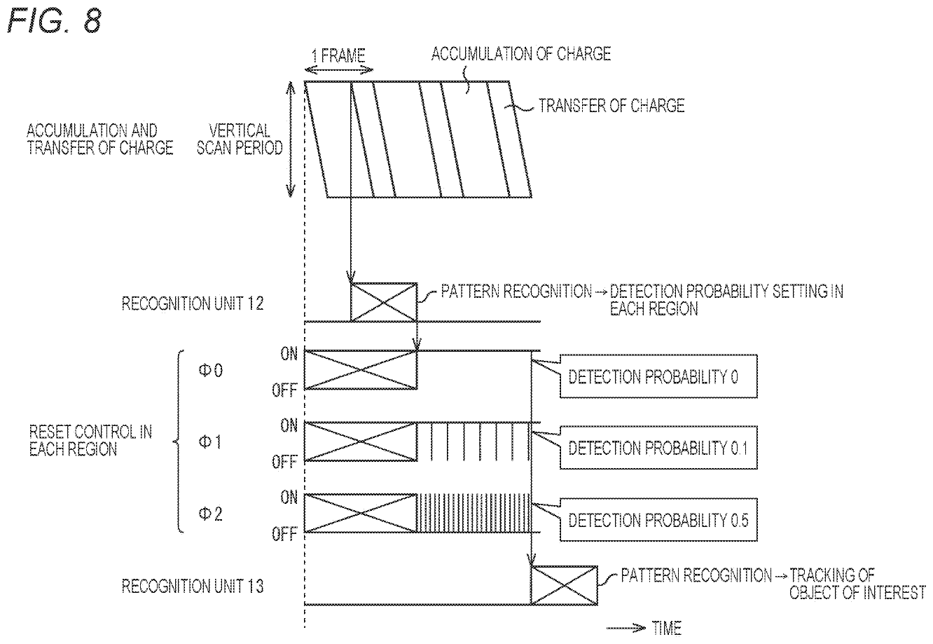

FIG. 8 is a diagram for explaining an example of the reset control that depends on detection probabilities and is performed in the second example configuration of a pixel circuit 21.

At the pixel 31 in each pixel circuit 21, electric charge is accumulated and is transferred for each horizontal scan line during the vertical scan period, as shown in FIG. 8. The photocurrent corresponding to the electric charge transferred from the pixel 31 is subjected to AD conversion at the ADC 33, and is output as a gradation signal. The recognition unit 12 performs pattern recognition on a gradation image whose pixel values are the gradation signals of each one frame, and, in accordance with the result of the pattern recognition, sets a detection probability in each unit region formed with one or more pixel circuits 21. Here, as for the three regions r0 to r2, a detection probability of 0 is set in the region r0, a detection probability of 0.1 is set in the region r1, and a detection probability of 0.5 is set in the region r2, as shown in FIG. 7.

The recognition unit 12 performs reset control to control resetting of the switch 74, in accordance with the detection probabilities.

As for the pixel circuits 21 in the region r0 having a detection probability p set to 0, reset control Φ0 is performed so that the switch 74 is not reset. As for the pixel circuits 21 in the region r1 having a detection probability p set to 0.1, reset control Φ1 is performed so that the switch 74 is reset at a rate of 0.1 of that in the case of the normal mode. As for the pixel circuits 21 in the region r2 having a detection probability p set to 0.5, reset control Φ2 is performed so that the switch 74 is reset at a rate of 0.5 of that in the case of the normal mode.

Here, a predetermined unit time is represented by T, and resetting of the switch 74 at a rate of p (0≤p≤1) of that in the case of the normal mode can be performed by enabling resetting only during a time p×T in the unit time T. The timing at which resetting is enabled can be selected periodically. Alternatively, a random number is generated at a predetermined clock timing, and the timing for enabling the resetting with a probability of p is selected in accordance with the random number. Thus, the resetting can be stochastically enabled only during the time p×T in the unit time T.

After the reset control depending on the detection probabilities is started in the recognition unit 12, the recognition unit 13 performs pattern recognition on an event image whose pixel value is the value corresponding to the event data output by the pixel circuit 21. In accordance with the result of the pattern recognition, tracking of the object of interest (following the object of interest) is performed.

[Third Example Configuration of a Pixel Circuit 21]

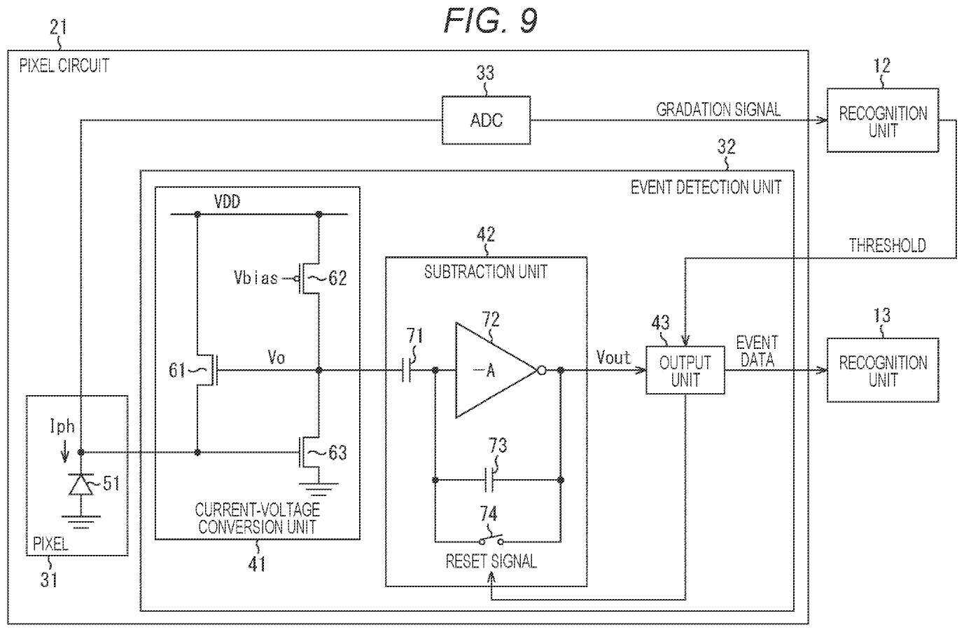

FIG. 9 is a block diagram showing a third example configuration of a pixel circuit 21 shown in FIG. 1.

Note that, in the drawing, the components equivalent to those in the case of FIG. 2 are denoted by the same reference numerals as those used in FIG. 2, and explanation of them will not be repeated in the description below.

In FIG. 9, the pixel circuit 21 includes components from pixels 31 to an ADC 33, and an event detection unit 32 includes components from a current-voltage conversion unit 41 to an output unit 43.

Accordingly, the pixel circuit 21 shown in FIG. 9 is designed in a manner similar to that in the case illustrated in FIG. 2.

However, as for the pixel circuit 21 shown in FIG. 9, the recognition unit 12 performs threshold control to control the threshold to be used for event detection at the output unit 43, as the control on the pixel circuit 21 depending on detection probabilities.

Using the threshold controlled by the recognition unit 12 as the threshold Vth to be compared with the difference signal Vout, the output unit 43 compares the difference signal Vout with the threshold Vth. In a case where the difference signal Vout is equal to or greater than the threshold +Vth, or is equal to or smaller than the threshold −Vth, the output unit 43 outputs event data of +1 or −1.

In FIG. 9, the recognition unit 12 performs the threshold control as described above, in accordance with detection probabilities. Thus, event detection is performed, and event data is output, in accordance with detection probabilities.

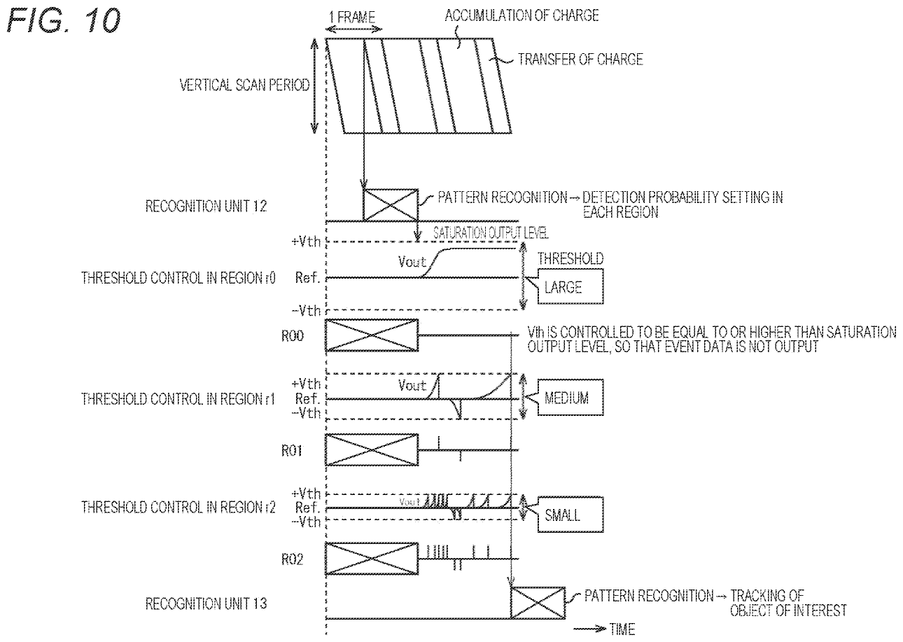

FIG. 10 is a diagram for explaining an example of the threshold control that depends on detection probabilities and is performed in the third example configuration of a pixel circuit 21.

At the pixel 31 in each pixel circuit 21, electric charge is accumulated and is transferred for each horizontal scan line during the vertical scan period, as shown in FIG. 10. The photocurrent corresponding to the electric charge transferred from the pixel 31 is subjected to AD conversion at the ADC 33, and is output as a gradation signal. The recognition unit 12 performs pattern recognition on a gradation image whose pixel values are the gradation signals of each one frame, and, in accordance with the result of the pattern recognition, sets a detection probability in each unit region formed with one or more pixel circuits 21. Here, as for the three regions r0 to r2, a detection probability of 0 is set in the region r0, a detection probability of 0.1 is set in the region r1, and a detection probability of 0.5 is set in the region r2, as shown in FIG. 7.

The recognition unit 12 performs threshold control to control the threshold in accordance with the detection probabilities.

As for the pixel circuits 21 in the region r0 having a detection probability p set to 0, threshold control is performed so that the difference signal Vout does not become equal to or greater than the threshold +Vth and does not become equal to or smaller than the threshold −Vth. As for the pixel circuits 21 in the region r1 having a detection probability p set to 0.1, threshold control is performed so that the difference signal Vout becomes equal to or greater than the threshold +Vth and becomes equal to or smaller than the threshold −Vth, at a rate of 0.1 of that in the case of the normal mode. As for the pixel circuits 21 in the region r2 having a detection probability p set to 0.5, threshold control is performed so that the difference signal Vout becomes equal to or greater than the threshold +Vth and becomes equal to or smaller than the threshold −Vth, at a rate of 0.5 of that in the case of the normal mode.

In the threshold control, the relationship between detection probabilities and the threshold for outputting event data in accordance with the detection probabilities is determined beforehand through simulations, for example. In accordance with the relationship, the threshold can be controlled to be the threshold for outputting event data in accordance with the detection probabilities.

As for the pixel circuits 21 in the region r0 having a detection probability p set to 0, threshold control can be performed so that the threshold +Vth becomes higher than the saturation output level of the difference signal Vout. In a case where threshold control is performed so that the threshold +Vth becomes higher than the saturation output level of the difference signal Vout, the difference signal Vout does not become equal to or greater than the threshold +Vth and does not become equal to or smaller than the threshold −Vth (with respect to a reference value Ref.). Accordingly, (the number of pieces of) the event data RO0 to be output from the pixel circuits 21 in the region r0 is zero.

As for the pixel circuits 21 in the region r1 having a detection probability p set to 0.1, threshold control can be performed so that the threshold +Vth becomes a predetermined value equal to or lower than the saturation output level of the difference signal Vout. Thus, the event data RO1 to be output by the pixel circuits 21 in the region r1 can be made to correspond to the detection probability of 0.1.

As for the pixel circuits 21 in the region r2 having a detection probability p set to 0.5, threshold control can be performed so that the threshold +Vth becomes a predetermined value that is smaller than the threshold set in the pixel circuits 21 in the region r1. Thus, the event data RO2 to be output by the pixel circuits 21 in the region r2 can be made to correspond to the detection probability of 0.5.

After the threshold control depending on the detection probabilities is started in the recognition unit 12, the recognition unit 13 performs pattern recognition on an event image whose pixel value is the value corresponding to the event data. In accordance with the result of the pattern recognition, tracking of the object of interest is performed.

[Fourth Example Configuration of a Pixel Circuit 21]

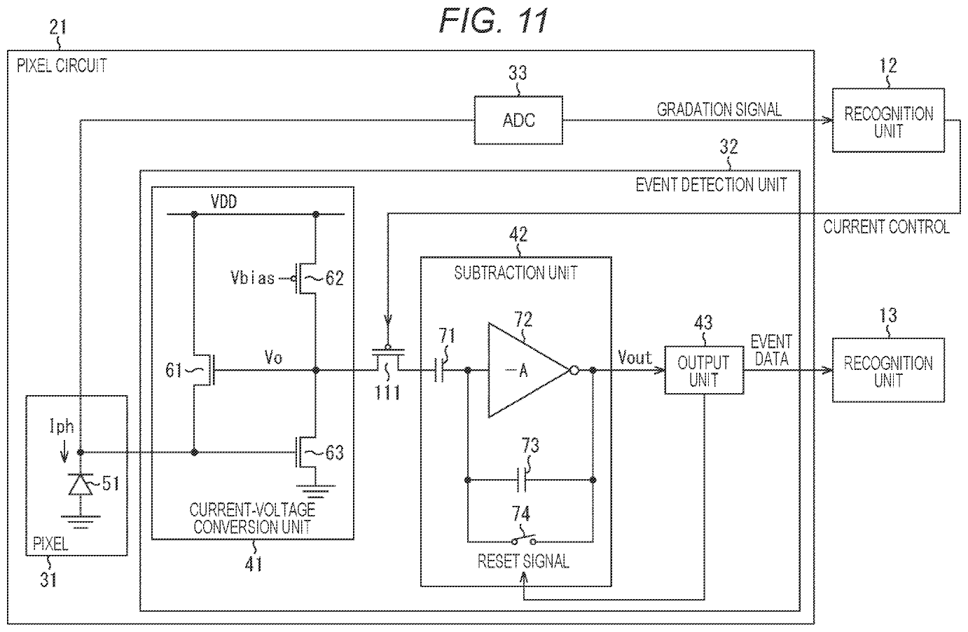

FIG. 11 is a block diagram showing a fourth example configuration of a pixel circuit 21 shown in FIG. 1.

Note that, in the drawing, the components equivalent to those in the case of FIG. 2 are denoted by the same reference numerals as those used in FIG. 2, and explanation of them will not be repeated in the description below.

In FIG. 11, the pixel circuit 21 includes components from pixels 31 to an ADC 33, and an event detection unit 32 includes components from a current-voltage conversion unit 41 to an output unit 43, and an FET 111.

Accordingly, the pixel circuit 21 in FIG. 11 is the same as that in the case illustrated in FIG. 2, in that the pixel circuit 21 includes the components from the pixels 31 to the ADC 33, and the event detection unit 32 includes the components from the current-voltage conversion unit 41 to the output unit 43.

However, the pixel circuit 21 in FIG. 11 differs from that in the case illustrated in FIG. 2, in that the FET 111 is newly provided between the current-voltage conversion unit 41 and the subtraction unit 42.

In FIG. 11, the recognition unit 12 performs current control to control the current flowing from (the connecting point between the FETs 62 and 63 of) the current-voltage conversion unit 41 to (the capacitor 71 of) the subtraction unit 42, as the control on the pixel circuit 21 in accordance with the detection probability.

The FET 111 is an FET of a PMOS, and controls the current flowing from the current-voltage conversion unit 41 to the subtraction unit 42, in accordance with the gate voltage control as the current control by the recognition unit 12. For example, the FET 111 is turned on and off, in accordance with the current control by the recognition unit 12. As the FET 111 is turned on and off, the current flow from the current-voltage conversion unit 41 to the subtraction unit 42 is turned on and off.

By turning on and off the FET 111 in accordance with the detection probability, the recognition unit 12 performs current control to control the current flow from the current-voltage conversion unit 41 to the subtraction unit 42. Thus, event data is output in accordance with the detection probability.

Note that the recognition unit 12 turns on and off the current flow from the current-voltage conversion unit 41 to the subtraction unit 42, and also controls the gate voltage of the FET 111. By doing so, the recognition unit 12 can adjust the amount of current flowing from the current-voltage conversion unit 41 to the subtraction unit 42, and adjust (delay) the time till the difference signal Vout becomes equal to or greater than the threshold +Vth, and the time till the difference signal Vout becomes equal to or smaller than the threshold −Vth.

As described above, the current flow from the current-voltage conversion unit 41 to the subtraction unit 42 is turned on and off, and also, the time till the difference signal Vout becomes equal to or greater than the threshold +Vth, and the time till the difference signal Vout becomes equal to or smaller than the threshold −Vth is adjusted, so that event data can be output in accordance with the detection probability.

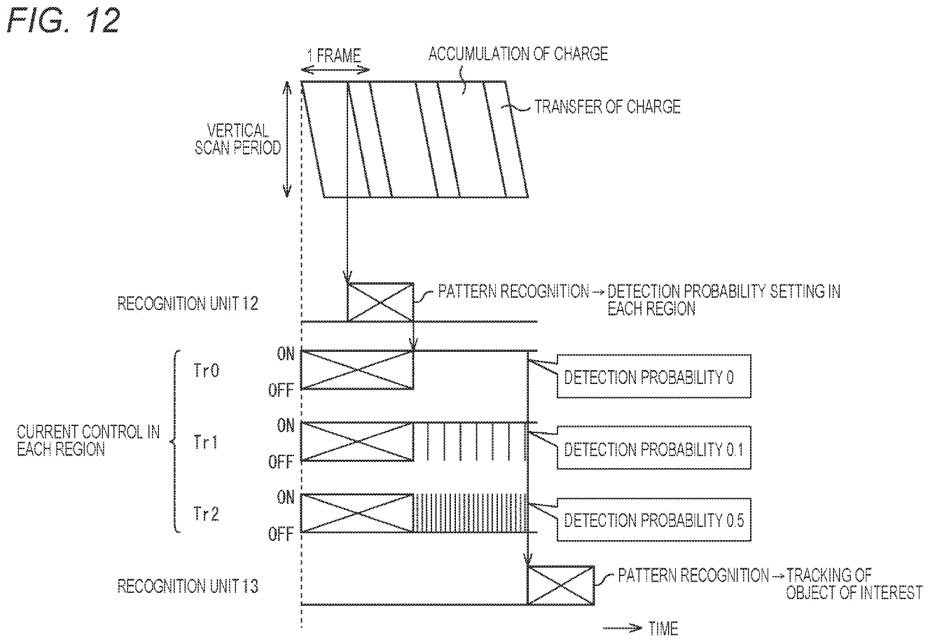

FIG. 12 is a diagram for explaining an example of the current control that depends on detection probabilities and is performed in the fourth example configuration of a pixel circuit 21.

At the pixel 31 in each pixel circuit 21, electric charge is accumulated and is transferred for each horizontal scan line during the vertical scan period, as shown in FIG. 12. The photocurrent corresponding to the electric charge transferred from the pixel 31 is subjected to AD conversion at the ADC 33, and is output as a gradation signal. The recognition unit 12 performs pattern recognition on a gradation image whose pixel values are the gradation signals of each one frame, and, in accordance with the result of the pattern recognition, sets a detection probability in each unit region formed with one or more pixel circuits 21. Here, as for the three regions r0 to r2, a detection probability of 0 is set in the region r0, a detection probability of 0.1 is set in the region r1, and a detection probability of 0.5 is set in the region r2, as shown in FIG. 7.

By turning on and off the FET 111 in accordance with the detection probability, the recognition unit 12 performs current control to control the flow of the current (hereinafter referred to as the detection current) from the current-voltage conversion unit 41 to the subtraction unit 42.

As for the pixel circuits 21 in the region r0 having a detection probability p set to 0, current control Tr0 is performed so that the detection current does not flow. As for the pixel circuits 21 in the region r1 having a detection probability p set to 0.1, current control Tr1 is performed so that the detection current flows at a rate of 0.1 (in time) of that in the case of the normal mode (a case where the detection current constantly flows). As for the pixel circuits 21 in the region r2 having a detection probability p set to 0.5, current control Tr2 is performed so that the detection current flows at a rate of 0.5 of that in the case of the normal mode.

Here, a predetermined unit time is represented by T, and applying the detection current at a rate of p (0≤p≤1) of that in the case of the normal mode can be performed by leaving the FET 111 on only during a time p×T in the unit time T. The timing at which the FET 111 is turned on can be selected periodically. Alternatively, a random number is generated at a predetermined clock timing, and the FET 111 is turned on with a probability of p in accordance with the random number, so that the detection current can be stochastically applied at the rate of p of that in the case of the normal mode.

After the current control depending on the detection probabilities is started in the recognition unit 12, the recognition unit 13 performs pattern recognition on an event image whose pixel value is the value corresponding to the event data. In accordance with the result of the pattern recognition, tracking of the object of interest is performed.

<Decimation of Event Data Outputs>

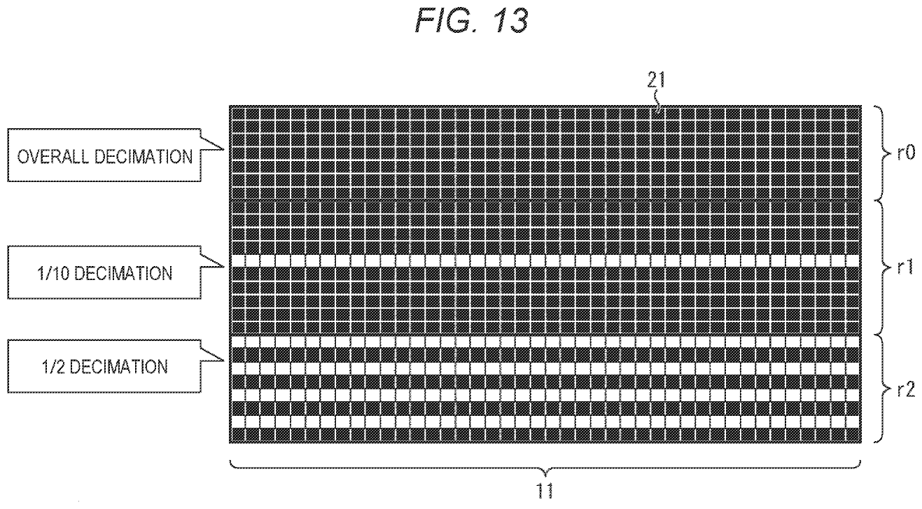

FIG. 13 is a diagram showing an example of spatial decimation of event data outputs.

A process of reducing the amount of event data by outputting event data in accordance with detection probabilities in the detection probability mode can be performed by decimating event data outputs from the pixel circuits 21 in accordance with the detection probabilities.

Here, decimating event data outputs to 1/N means that event data is output for one event out of N events, and event data is not output for the N−1 events. Not outputting event data can be realized through the reset control, the threshold control, or the current control described above. Further, not outputting event data means not operating the pixel circuits 21 (for example, not supplying power), or operating the pixel circuits 21 but limiting event data outputs from the output unit 43.

Event data outputs can be performed spatially or temporally.

FIG. 13 shows an example of spatial decimation of event data outputs.

Here, as for the three regions r0 to r2, the recognition unit 12 sets a detection probability of 0 in the region r0, a detection probability of 0.1 in the region r1, and a detection probability of 0.5 in the region r2, as shown in FIG. 7, for example.

The recognition unit 12 can control the pixel circuits 21 so that event data outputs are spatially decimated to 1/p in accordance with a detection probability p.

As for the pixel circuits 21 in the region r0 having a detection probability p set to 0, the pixel circuits 21 are controlled so that the number of the pixel circuits 21 that output event data becomes 0 (or all the event data outputs are decimated). As for the pixel circuits 21 in the region r1 having a detection probability p set to 0.1, the pixel circuits 21 are controlled so that the number of the pixel circuits 21 that output event data is decimated to 1/10. As for the pixel circuits 21 in the region r2 having a detection probability p set to 0.5, the pixel circuits 21 are controlled so that the number of the pixel circuits 21 that output event data is decimated to ½.

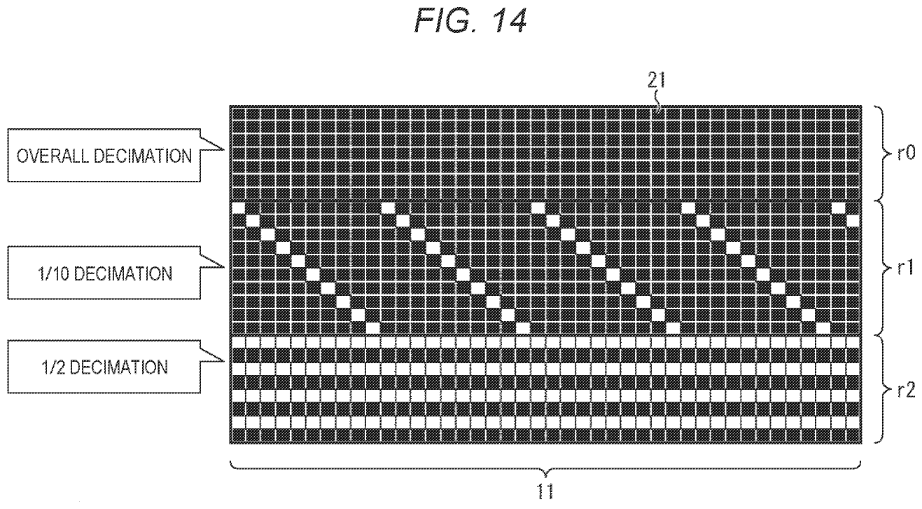

In FIG. 13, the portions shown in white represent the pixel circuits 21 that output event data, and the portions shown in black represent the pixel circuits 21 that do not output event data. The same applies in FIG. 14 described later.

In FIG. 13, the pixel circuits 21 are controlled so that event data outputs are decimated on the basis of horizontal scan lines.

FIG. 14 is a diagram showing another example of spatial decimation of event data outputs.

In FIG. 14, the pixel circuits 21 are controlled so that event data outputs are decimated in a manner similar to that illustrated in FIG. 13.

In FIG. 14, however, as for the pixel circuits 21 in the region r1 having a detection probability p set to 0.1, the pixel circuits 21 are controlled so that event data outputs are decimated in the horizontal direction on the basis of a unit of a predetermined number of pixel circuits 21.

It is possible to perform spatial decimation on event data outputs by spatially and periodically selecting the pixel circuits 21 to output event data, or by randomly selecting the pixel circuits 21.

Alternatively, as for each pixel circuit 21, a random number is generated, and the pixel circuits 21 to output event data are selected with a probability of p in accordance with the random number. In this manner, event data outputs from the pixel circuits 21 can be spatially decimated stochastically in accordance with the detection probability p.

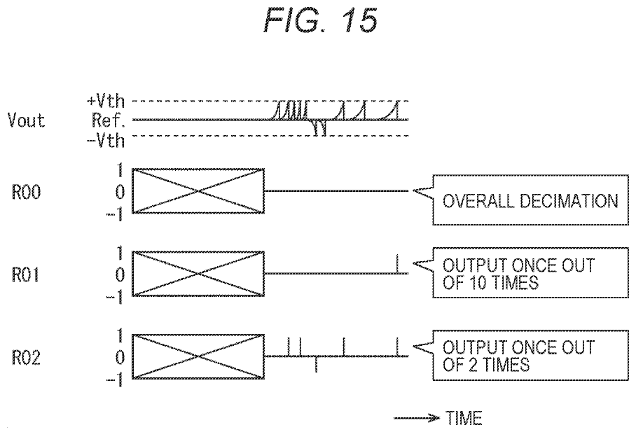

FIG. 15 is a diagram showing an example of temporal decimation of event data outputs.

Here, as for the three regions r0 to r2, the recognition unit 12 sets a detection probability of 0 in the region r0, a detection probability of 0.1 in the region r1, and a detection probability of 0.5 in the region r2, as shown in FIG. 7, for example.

The recognition unit 12 can control the pixel circuits 21 so that event data outputs are temporally decimated to 1/p in accordance with a detection probability p.

As for the event data RO0 to be output from the pixel circuits 21 in the region r0 having a detection probability p set to 0, the pixel circuits 21 are controlled so that the number of times event data is output for an event becomes 0 (or all the event data outputs are decimated).

As for the event data RO1 to be output from the pixel circuits 21 in the region r1 having a detection probability p set to 0.1, the pixel circuits 21 are controlled so that the number of times event data is output for an event is decimated to 1/10. For example, in a case where the difference signal Vout becomes equal to or greater than the threshold +Vth ten times, or becomes equal to or smaller than the threshold −Vth ten times, the pixel circuits 21 are controlled so that event data is output only once out of the ten times.

As for the event data RO2 to be output from the pixel circuits 21 in the region r2 having a detection probability p set to 0.5, the pixel circuits 21 are controlled so that the number of times event data is output for an event is decimated to ½. For example, in a case where the difference signal Vout becomes equal to or greater than the threshold +Vth two times, or becomes equal to or smaller than the threshold −Vth two times, the pixel circuits 21 are controlled so that event data is output only once out of the two times.

In a case where event data outputs are temporally decimated, the timing to output event data for an event can be selected periodically or randomly.

Alternatively, as for an event, a random number is generated, and outputting event data is selected with a probability of p in accordance with the random number for each event. In this manner, event data outputs from the pixel circuits 21 can be temporally decimated stochastically in accordance with the detection probability p.

<Example Applications to Mobile Structures>

The technology (the present technology) according to the present disclosure can be applied to various products. For example, the technology according to the present disclosure may be embodied as a device mounted on any type of mobile structure, such as an automobile, an electrical vehicle, a hybrid electrical vehicle, a motorcycle, a bicycle, a personal mobility device, an airplane, a drone, a vessel, or a robot.

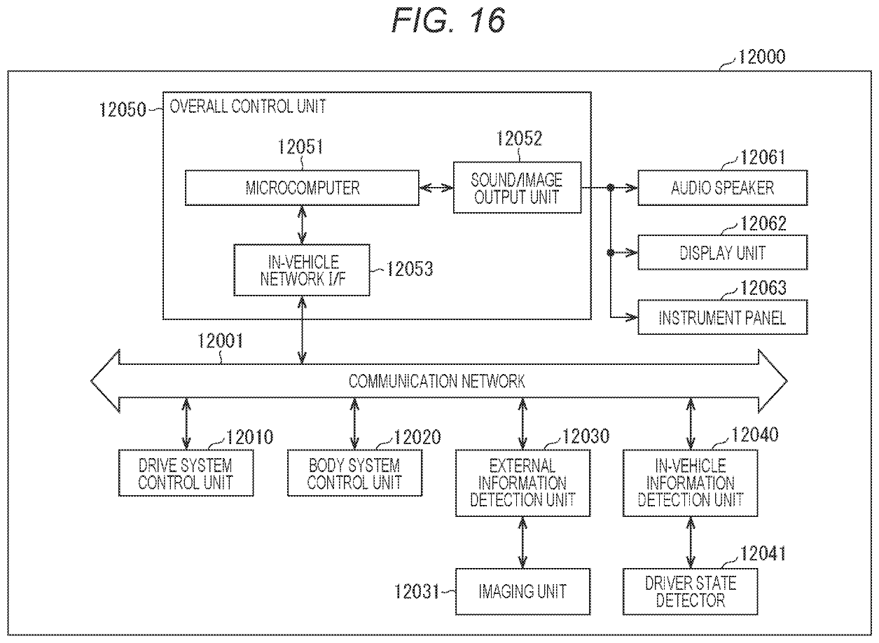

FIG. 16 is a block diagram schematically showing an example configuration of a vehicle control system that is an example of a mobile structure control system to which the technology according to the present disclosure may be applied.

A vehicle control system 12000 includes a plurality of electronic control units connected via a communication network 12001. In the example shown in FIG. 16, the vehicle control system 12000 includes a drive system control unit 12010, a body system control unit 12020, an external information detection unit 12030, an in-vehicle information detection unit 12040, and an overall control unit 12050. Further, a microcomputer 12051, a sound/image output unit 12052, and an in-vehicle network interface (I/F) 12053 are shown as the functional components of the overall control unit 12050.

The drive system control unit 12010 controls operations of the devices related to the drive system of the vehicle according to various programs. For example, the drive system control unit 12010 functions as control devices such as a driving force generation device for generating a driving force of the vehicle such as an internal combustion engine or a driving motor, a driving force transmission mechanism for transmitting the driving force to the wheels, a steering mechanism for adjusting the steering angle of the vehicle, and a braking device for generating a braking force of the vehicle.

The body system control unit 12020 controls operations of the various devices mounted on the vehicle body according to various programs. For example, the body system control unit 12020 functions as a keyless entry system, a smart key system, a power window device, or a control device for various lamps such as a headlamp, a backup lamp, a brake lamp, a turn signal lamp, a fog lamp, or the like. In this case, the body system control unit 12020 can receive radio waves transmitted from a portable device that substitutes for a key, or signals from various switches. The body system control unit 12020 receives inputs of these radio waves or signals, and controls the door lock device, the power window device, the lamps, and the like of the vehicle.

The external information detection unit 12030 detects information outside the vehicle equipped with the vehicle control system 12000. For example, an imaging unit 12031 is connected to the external information detection unit 12030. The external information detection unit 12030 causes the imaging unit 12031 to capture an image of the outside of the vehicle, and receives the captured image. On the basis of the received image, the external information detection unit 12030 may perform an object detection process for detecting a person, a vehicle, an obstacle, a sign, characters on the road surface, or the like, or perform a distance detection process.

The imaging unit 12031 is an optical sensor that receives light, and outputs an electrical signal corresponding to the amount of received light. The imaging unit 12031 can output an electrical signal as an image, or output an electrical signal as distance measurement information. Further, the light to be received by the imaging unit 12031 may be visible light, or may be invisible light such as infrared rays.

The in-vehicle information detection unit 12040 detects information about the inside of the vehicle. For example, a driver state detector 12041 that detects the state of the driver is connected to the in-vehicle information detection unit 12040. The driver state detector 12041 includes a camera that captures an image of the driver, for example, and, on the basis of detected information input from the driver state detector 12041, the in-vehicle information detection unit 12040 may calculate the degree of fatigue or the degree of concentration of the driver, or determine whether or not the driver is dozing off.

On the basis of the external/internal information acquired by the external information detection unit 12030 or the in-vehicle information detection unit 12040, the microcomputer 12051 can calculate the control target value of the driving force generation device, the steering mechanism, or the braking device, and output a control command to the drive system control unit 12010. For example, the microcomputer 12051 can perform cooperative control to achieve the functions of an advanced driver assistance system (ADAS), including vehicle collision avoidance or impact mitigation, follow-up running based on the distance between vehicles, vehicle velocity maintenance running, vehicle collision warning, vehicle lane deviation warning, or the like.

Further, the microcomputer 12051 can also perform cooperative control to conduct automatic driving or the like for autonomously running not depending on the operation of the driver, by controlling the driving force generation device, the steering mechanism, the braking device, or the like on the basis of information about the surroundings of the vehicle, the information having being acquired by the external information detection unit 12030 or the in-vehicle information detection unit 12040.

The microcomputer 12051 can also output a control command to the body system control unit 12020, on the basis of the external information acquired by the external information detection unit 12030. For example, the microcomputer 12051 controls the headlamp in accordance with the position of the leading vehicle or the oncoming vehicle detected by the external information detection unit 12030, and performs cooperative control to achieve an anti-glare effect by switching from a high beam to a low beam, or the like.

The sound/image output unit 12052 transmits an audio output signal and/or an image output signal to an output device that is capable of visually or audibly notifying the passenger(s) of the vehicle or the outside of the vehicle of information. In the example shown in FIG. 16, an audio speaker 12061, a display unit 12062, and an instrument panel 12063 are shown as output devices. The display unit 12062 may include an on-board display and/or a head-up display, for example.

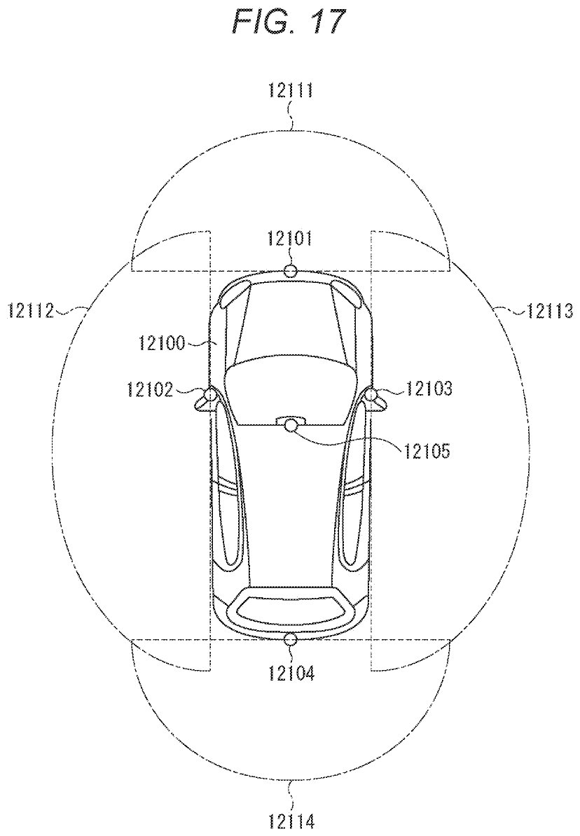

FIG. 17 is a diagram showing an example of installation positions of imaging units 12031.

In FIG. 17, a vehicle 12100 includes imaging units 12101, 12102, 12103, 12104, and 12105 as the imaging units 12031.

Imaging units 12101, 12102, 12103, 12104, and 12105 are provided at the following positions: the front end edge of a vehicle 12100, a side mirror, the rear bumper, a rear door, an upper portion of the front windshield inside the vehicle, and the like, for example. The imaging unit 12101 provided on the front end edge and the imaging unit 12105 provided on the upper portion of the front windshield inside the vehicle mainly capture images ahead of the vehicle 12100. The imaging units 12102 and 12103 provided on the side mirrors mainly capture images on the sides of the vehicle 12100. The imaging unit 12104 provided on the rear bumper or a rear door mainly captures images behind the vehicle 12100. The front images acquired by the imaging units 12101 and 12105 are mainly used for detection of a vehicle running in front of the vehicle 12100, a pedestrian, an obstacle, a traffic signal, a traffic sign, a lane, or the like.

Note that FIG. 17 shows an example of the imaging ranges of the imaging units 12101 to 12104. An imaging range 12111 indicates the imaging range of the imaging unit 12101 provided on the front end edge, imaging ranges 12112 and 12113 indicate the imaging ranges of the imaging units 12102 and 12103 provided on the respective side mirrors, and an imaging range 12114 indicates the imaging range of the imaging unit 12104 provided on the rear bumper or a rear door. For example, images captured from image data by the imaging units 12101 to 12104 are superimposed on one another, so that an overhead image of the vehicle 12100 viewed from above is obtained.

At least one of the imaging units 12101 to 12104 may have a function of acquiring distance information. For example, at least one of the imaging units 12101 to 12104 may be a stereo camera including a plurality of imaging elements, or may be imaging elements having pixels for phase difference detection.

For example, on the basis of distance information obtained from the imaging units 12101 to 12104, the microcomputer 12051 calculates the distances to the respective three-dimensional objects within the imaging ranges 12111 to 12114, and temporal changes in the distances (the velocities relative to the vehicle 12100). In this manner, the three-dimensional object that is the closest three-dimensional object on the traveling path of the vehicle 12100 and is traveling at a predetermined velocity (0 km/h or higher, for example) in substantially the same direction as the vehicle 12100 can be extracted as the vehicle running in front of the vehicle 12100. Further, the microcomputer 12051 can set beforehand an inter-vehicle distance to be maintained in front of the vehicle running in front of the vehicle 12100, and can perform automatic brake control (including follow-up stop control), automatic acceleration control (including follow-up start control), and the like. In this manner, it is possible to perform cooperative control to conduct automatic driving or the like to autonomously travel not depending on the operation of the driver.

For example, in accordance with the distance information obtained from the imaging units 12101 to 12104, the microcomputer 12051 can extract three-dimensional object data concerning three-dimensional objects under the categories of two-wheeled vehicles, regular vehicles, large vehicles, pedestrians, utility poles, and the like, and use the three-dimensional object data in automatically avoiding obstacles. For example, the microcomputer 12051 classifies the obstacles in the vicinity of the vehicle 12100 into obstacles visible to the driver of the vehicle 12100 and obstacles difficult to visually recognize. The microcomputer 12051 then determines collision risks indicating the risks of collision with the respective obstacles. If a collision risk is equal to or higher than a set value, and there is a possibility of collision, the microcomputer 12051 can output a warning to the driver via the audio speaker 12061 and the display unit 12062, or can perform driving support for avoiding collision by performing forced deceleration or avoiding steering via the drive system control unit 12010.

At least one of the imaging units 12101 to 12104 may be an infrared camera that detects infrared rays. For example, the microcomputer 12051 can recognize a pedestrian by determining whether or not a pedestrian exists in images captured by the imaging units 12101 to 12104. Such pedestrian recognition is carried out through a process of extracting feature points from the images captured by the imaging units 12101 to 12104 serving as infrared cameras, and a process of performing a pattern matching on the series of feature points indicating the outlines of objects and determining whether or not there is a pedestrian, for example. If the microcomputer 12051 determines that a pedestrian exists in the images captured by the imaging units 12101 to 12104, and recognizes a pedestrian, the sound/image output unit 12052 controls the display unit 12062 to display a rectangular contour line for emphasizing the recognized pedestrian in a superimposed manner. Further, the sound/image output unit 12052 may also control the display unit 12062 to display an icon or the like indicating the pedestrian at a desired position.

An example of a vehicle control system to which the technology according to the present disclosure may be applied has been described above. The technology according to the present disclosure can be applied to the imaging units 12031 among the components described above, for example. Specifically, the DVS shown in FIG. 1 can be applied to the imaging units 12031. As the technology according to the present disclosure is applied to the imaging units 12031, the latency can be shortened, and overlooking of objects can be reduced. As a result, appropriate drive support can be performed.

Note that embodiments of the present technology are not limited to the above described embodiments, and various modifications may be made to them without departing from the scope of the present technology.

Meanwhile, the advantageous effects described in this specification are merely examples, and the advantageous effects of the present technology are not limited to them and may include other effects.

It should be noted that the present technology may also be embodied in the configurations described below.

<1>

An event signal detection sensor including:

a plurality of pixel circuits that detect an event that is a change in an electrical signal of a pixel that generates the electrical signal by performing photoelectric conversion, and output event data indicating occurrence of the event; and

a detection probability setting unit that calculates, in accordance with a result of pattern recognition, a detection probability per unit time for detecting the event for each region formed with one or more of the pixel circuits, and controls the pixel circuits in such a manner that the event data is output in accordance with the detection probability.

<2>

The event signal detection sensor according to <1>, in which

the pixel circuit includes a subtraction unit including a first capacitance, and a second capacitance forming a switched capacitor, the subtraction unit calculating a difference signal corresponding to a difference between voltages at different timings of a voltage corresponding to a photocurrent of the pixel, and

the detection probability setting unit performs reset control to control resetting of the second capacitance in such a manner that the event data is output in accordance with the detection probability.

<3>

The event signal detection sensor according to <1>, in which

the detection probability setting unit performs threshold control to control a threshold to be used in detecting the event, in such a manner that the event data is output in accordance with the detection probability.

<4>

The event signal detection sensor according to <1>, in which

the pixel circuit includes:

a current-voltage conversion unit that converts a photocurrent of the pixel into a voltage corresponding to the photocurrent; and

a subtraction unit that calculates a difference signal corresponding to a difference between voltages at different timings of the voltage, and

the detection probability setting unit performs current control to control a current flowing from the current-voltage conversion unit to the subtraction unit, in such a manner that the event data is output in accordance with the detection probability.

<5>

The event signal detection sensor according to <4>, in which

the pixel circuit includes a transistor that controls the current flowing from the current-voltage conversion unit to the subtraction unit.

<6>

The event signal detection sensor according to <1>, in which

the detection probability setting unit spatially decimates event data outputs from the pixel circuits in such a manner that the event data is output in accordance with the detection probability.

<7>

The event signal detection sensor according to <1>, in which

the detection probability setting unit temporally decimates event data outputs from the pixel circuits in such a manner that the event data is output in accordance with the detection probability.

<8>

The event signal detection sensor according to any one of <1> to <7>, in which

the detection probability setting unit sets a region of interest (ROI), calculates a detection probability of 1 in the ROI, and calculates a detection probability smaller than 1 in another region, in accordance with a result of the pattern recognition.

<9>

The event signal detection sensor according to any one of <1> to <8>, in which

the detection probability setting unit calculates a detection probability corresponding to a priority level assigned to an object in a region of the pixel circuit at which light from the object recognized through the pattern recognition has been received.

<10>

The event signal detection sensor according to <1>, in which,

depending on a random number, the detection probability setting unit controls the pixel circuit in such a manner that the event data is output in accordance with the detection probability.

<11>

A control method including

controlling a plurality of pixel circuits of an event signal detection sensor that includes: the pixel circuits that detect an event that is a change in an electrical signal of a pixel that generates the electrical signal by performing photoelectric conversion, and output event data indicating occurrence of the event,

in which the pixel circuits are controlled in accordance with a result of pattern recognition, in such a manner that a detection probability per unit time for detecting the event is calculated for each region formed with one or more of the pixel circuits, and the event data is output in accordance with the detection probability.

### REFERENCE SIGNS LIST

11 Pixel array unit
12, 13 Recognition unit
21 Pixel circuit
31 Pixel
32 Event detection unit
33 ADC
41 Current-voltage conversion unit
42 Subtraction unit
43 Output unit
51 PD
61 to 63 FET
71 Capacitor
72 Operational amplifier
73 Capacitor
74 Switch
101 OR gate
111 FET

1. An event signal detection sensor comprising:
a plurality of pixel circuits that detect an event that is a change in an electrical signal of a pixel that generates the electrical signal by performing photoelectric conversion, and output event data indicating occurrence of the event; and
a detection probability setting unit that calculates, in accordance with a result of pattern recognition, a detection probability per unit time for detecting the event for each region formed with at least one of the pixel circuits, and controls the pixel circuits in such a manner that the event data is output in accordance with the detection probability.

2. The event signal detection sensor according to claim 1, wherein
the pixel circuit includes a subtraction unit including a first capacitance, and a second capacitance forming a switched capacitor, the subtraction unit calculating a difference signal corresponding to a difference between voltages at different timings of a voltage corresponding to a photocurrent of the pixel, and
the detection probability setting unit performs reset control to control resetting of the second capacitance in such a manner that the event data is output in accordance with the detection probability.

3. The event signal detection sensor according to claim 1, wherein
the detection probability setting unit performs threshold control to control a threshold to be used in detecting the event, in such a manner that the event data is output in accordance with the detection probability.

4. The event signal detection sensor according to claim 1, wherein
the pixel circuit includes:
a current-voltage conversion unit that converts a photocurrent of the pixel into a voltage corresponding to the photocurrent; and
a subtraction unit that calculates a difference signal corresponding to a difference between voltages at different timings of the voltage, and
the detection probability setting unit performs current control to control a current flowing from the current-voltage conversion unit to the subtraction unit, in such a manner that the event data is output in accordance with the detection probability.

5. The event signal detection sensor according to claim 4, wherein
the pixel circuit includes a transistor that controls the current flowing from the current-voltage conversion unit to the subtraction unit.

6. The event signal detection sensor according to claim 1, wherein
the detection probability setting unit spatially decimates event data outputs from the pixel circuits in such a manner that the event data is output in accordance with the detection probability.

7. The event signal detection sensor according to claim 1, wherein
the detection probability setting unit temporally decimates event data outputs from the pixel circuits in such a manner that the event data is output in accordance with the detection probability.

8. The event signal detection sensor according to claim 1, wherein
the detection probability setting unit sets a region of interest (ROI), calculates a detection probability of 1 in the ROI, and calculates a detection probability smaller than 1 in another region, in accordance with a result of the pattern recognition.

9. The event signal detection sensor according to claim 1, wherein
the detection probability setting unit calculates a detection probability corresponding to a priority level assigned to an object in a region of the pixel circuit at which light from the object recognized through the pattern recognition has been received.

10. The event signal detection sensor according to claim 1, wherein,
depending on a random number, the detection probability setting unit controls the pixel circuit in such a manner that the event data is output in accordance with the detection probability.

11. A control method comprising
controlling a plurality of pixel circuits of an event signal detection sensor that includes: the pixel circuits that detect an event that is a change in an electrical signal of a pixel that generates the electrical signal by performing photoelectric conversion, and output event data indicating occurrence of the event,
wherein the pixel circuits are controlled in accordance with a result of pattern recognition, in such a manner that a detection probability per unit time for detecting the event is calculated for each region formed with at least one of the pixel circuits, and the event data is output in accordance with the detection probability.
